(19) United States
(12) Patent Application Publication
(10) Pub. No.: US 2019/0080271 A1
(43) Pub. Date: Mar. 14, 2019

(54) Coordinated Production and Transportation Scheduling Method and System Based on Improved Tabu Search Algorithm

(71) Applicant: Hefei University of Technology, Hefei (CN)

(72) Inventors: Jun PEI, Hefei (CN); Qingru SONG, Hefei (CN); Xinbao LIU, Hefei (CN); Shaojun LU, Hefei (CN); Qiang ZHANG, Hefei (CN); Wenjuan FAN, Hefei (CN); Min KONG, Hefei (CN)

(21) Appl. No.: 16/127,350

(22) Filed: Sep. 11, 2018

(30) Foreign Application Priority Data
Sep. 11, 2017 (CN) 201710813169.2

(51) Int. Cl. G06Q 10/06; G06F 7/58; G06F 17/30

(52) U.S. Cl. CPC G06Q 10/06311; G06F 17/30979; G06F 7/58

(57) ABSTRACT

The present invention discloses a coordinated production and transportation scheduling method and system based on an improved tabu search algorithm, and a storage medium. The method includes batching jobs, initializing algorithm parameters, generating an initial solution, generating a neighborhood solution set, performing mutation, crossover and selection on individuals, determining a candidate solution set; calculating a fitness value of an individual, updating the candidate solution set; updating a tabu list, and determining whether an algorithm termination condition is satisfied; if yes, outputting the global optimal solution; otherwise, returning to the step 4. The present invention is mainly aimed at the coordinated production and transportation batch scheduling problem with multiple manufacturers. The whole profit of an enterprise in the production and transportation phases can be maximized, and high quality services can be provided for customers of the enterprise with improved core competitiveness of the enterprise.

### CROSS-REFERENCE TO RELATED APPLICATIONS

This application claims to Chinese application no. 201710813169.2 with a filing date of Sep. 11, 2017. The content of the aforementioned application, including any intervening amendments thereto, are incorporated herein by reference.

### TECHNICAL FIELD

The present invention relate to the technical field of software, and more particularly, to a coordinated production and transportation scheduling method and system based on an improved tabu search algorithm, and a storage medium.

### BACKGROUND OF THE PRESENT INVENTION

Batch scheduling problems, as a type of typical combinatorial optimization problems, have been widely found in modern production activities, such as traffic and transportation, production and transportation, ship lock and other fields. In the batch scheduling problem with uniform parallel machines, all machines may have the same processing capacity but different processing speeds, and a plurality of jobs can be processed at the same time within the capabilities of batch processing machines. In the background of current mainstream cloud manufacturing mode, in order to make full use of existing production resources to provide customers with high quality services, enterprises may cooperate with each other to fulfill the production task of one customer's order. To design a scientific, reasonable production scheduling scheme with distributed uniform machines can not only make full use of social production resources, but also promote the improvement of productive capacities of enterprises. Therefore, for the batch scheduling problem with distributed uniform parallel machines, how to determine a reasonable and effective production scheduling scheme has become an urgent problem for enterprises to solve, and the study of such a problem has important practical significance.

In previous studies, intelligent algorithms and heuristic algorithms were extensively applied to solve the coordinated production and transportation scheduling problem in complex conditions. In one aspect, there have been studies focused on the batch scheduling problems with identical parallel machines and non-identical job sizes, where jobs differ in size and processing time, and a hybrid simulated annealing and genetic algorithm has been developed to solve this problem. In another aspect, there have been studies with considerations of differences in processing time, release date, cut-off time and size, and a swarm algorithm has been developed to solve this problem. Further, there have been studies with considerations of dynamic arrivals of jobs in each batch processing machines in distributed environment and transportation time before and after processing, and a plurality of heuristic algorithms have been developed for this problem. In this article, an improved tabu search algorithm is designed for the coordinated production and transportation batch scheduling problem with uniform parallel machines and multiple manufacturers, and an assignment scheme of various job batches to machines is determined by this algorithm, thus obtaining a coordinated production and transportation scheduling scheme that can maximize the whole profit in the production and transportation phases. The tabu search algorithm generally includes the following steps: (1) generating an initial solution; (2) generating neighborhood solutions; (3) determining candidate solutions; (4) picking out the optimal individual conforming to a tabu rule from a candidate solution set; (5) updating the candidate solution set; (6) updating a tabu list; and (7) updating the global optimal solution. The optimal solution, i.e., the optimal coordinated production and transportation scheduling scheme, can be searched and obtained in the whole solution space by repeating the above steps.

However, during the process of invention-creation, the inventor has found that the prior art has some disadvantages as follows: (1) with regard to study, the previous studies are mainly focused on identical parallel machines, and there have been few studies focused on the batch scheduling problem with uniform machines relatively; in addition, there have been few research results with considerations of both production and transportation under the circumstance of uniform machines. In actual production activities, the production task of one order may be completed by a plurality of enterprises cooperatively. The processing machines of those enterprises may not be completely the same in processing speed due to different production conditions of the enterprises. When solving such a scheduling problem, differences of jobs need to be considered, and the effect of the difference between machines on the optimization of makespan in the problem also needs to be considered at the same time. (2) With regard to study method, the performance of the tabu search algorithm may be affected by factors such as determination of candidate solutions, tabu rule, tabu list length and the like.

### SUMMARY OF THE PRESENT INVENTION

The present invention provide a coordinated production and transportation scheduling method and system based on an improved tabu search algorithm and a storage medium to solve at least one of the above technical problems.

In a first aspect, an embodiment of the present invention provides a coordinated production and transportation scheduling method based on an improved tabu search algorithm. The method is executed by a computer and includes:

S1, sorting all jobs in a job set J={J₁, . . . , Jᵢ, . . . , Jₙ} in non-increasing order by basic processing time, thereby obtaining a sorted job set J′={J′₁, . . . , J′ᵢ, . . . , J′ₙ};

S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;

S3, repeating the step S2 until all jobs of the job set J′ are assigned to corresponding batches, thereby forming a batch set denoted as B={b₁, . . . , b_{d}, . . . , bₗ};

S4, initializing input parameters of the algorithm, the input parameters including number of jobs n, job size s, basic processing time of a job P, number of processing machines m, time needed for a job to arrive at a processing machine r, maximum number of jobs that each batch is capable of holding C and processing speed v, as well as time needed for transporting jobs from each processing machine T;

S5, setting execution parameters of the algorithm, the execution parameters including maximum iterations Iₘₐₓ current iteration I−1, crossover probability CR, and initial solution of the algorithm Xₛ={x₁, . . . , x_{d}, . . . , xₗ}, wherein x_{d} represents that the dth batch is assigned to machine x_{d}, with the global optimal solution X_{best}=Xₛ;

S6, generating a neighborhood solution set N (Xₛ) according to the initial solution Xₛ, updating individuals in N (Xₛ), and determining a candidate solution set List(Xₛ);

S7, determining whether List (Xₛ) is a null set; if yes, performing step S12; otherwise, picking out the optimal individual Y from List (Xₛ);

S8, determining whether the individual Y is better than the global optimal solution X_{best}; if yes, assigning Y to X_{best} and performing step S11; otherwise, performing step S9;

S9, determining whether the individual Y obtained at step S7 conforms to a tabu rule in a tabu list TSList; if yes, performing step S10; otherwise, performing step S11;

S10, updating the candidate solution set List (Xₛ)), moving the individual Y out of the set List (Xₛ), and returning to the step S7;

S11, determining whether a new individual Y is obtained; and if the individual Y is updated, assigning Y to Xₛ;

S12, updating the tabu list TSList according to the initial solution Xₛ; and

S13, assigning I+1 to I, determining whether I≤Iₘₐₓ is true, and if yes, returning to the step S6; otherwise, terminating the execution of the algorithm, and outputting a fitness value of the optimal solution X_{best}, a batching scheme of jobs in the job set and an assignment scheme of job batches to each processing machine.

As described above, setting the initial solution of the algorithm Xₛ=x₁, . . . , x_{d}, . . . , xₗ) in the step S5 includes:

step S51, sorting all batches in the batch set B={b₁, . . . , b_{d}, . . . , bₗ} in non-increasing order by processing length, thereby forming a sorted batch set denoted as B′={b′₁, . . . , b′_{d}, . . . , b′ₗ};

step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;

step S53, defining variables d=1 and k=1;

step S54, assigning Mₖ to x_{d};

step S55, assigning k+1 to k, and determining whether k≤m is true; if yes, performing step S56; otherwise, letting k=1, and performing step S56; and

step S56, assigning d+1 to d, and determining whether d≤l is true; if yes, returning to the step S54; otherwise, taking X={x₁, . . . , x_{d}, . . . , xₗ} as the initial solution Xₛ.

In a second aspect, an embodiment of the present invention provides a coordinated production and transportation scheduling system based on an improved tabu search algorithm. The scheduling system includes a computer including:

at least one storage unit;

at least one processing unit; and

at least one output unit;

The at least one storage unit stores at least one instruction to be loaded and executed by the at least one processing unit to implement the following steps:

S1, sorting all jobs in a job set J={J₁, . . . , Jᵢ, . . . , Jₙ} in non-increasing order by basic processing time, thereby obtaining a sorted job set J′={J′₁, . . . , J′ᵢ, . . . , J′ₙ};

S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;

S3, repeating the step S2 until all jobs of the job set J′ are assigned to corresponding batches, thereby forming a batch set denoted as B={b₁, . . . , b_{d}, . . . , bₗ}, wherein b_{d} represents the dth batch, and l represents the number of batches;

S4, initializing input parameters of the algorithm, the input parameters including number of jobs n, job size s, basic processing time of a job p, number of processing machines m, time needed for a job to arrive at a processing machine r, maximum number of jobs that each batch is capable of holding C and processing speed v, as well as time needed for transporting jobs from each processing machine T;

S5, setting execution parameters of the algorithm, the execution parameters including maximum iterations Iₘₐₓ, current iteration I−1, crossover probability CR, and initial solution of the algorithm Xₛ={x₁, . . . , x_{d}, . . . , xₗ}, wherein x_{d} represents that the dth batch is assigned to machine x_{d}, with the global optimal solution X_{best}=Xₛ;

S6, generating a neighborhood solution set N(Xₛ) according to the initial solution Xₛ, updating individuals in N(Xₛ), and determining a candidate solution set List(Xₛ);

S7, determining whether List (Xₛ) is a null set; if yes, performing step S12; otherwise, picking out the optimal individual Y from List (Xₛ);

S8, determining whether the individual Y is better than the global optimal solution X_{best}; if yes, assigning Y to X^{best} and performing step S11; otherwise, performing step S9;

S9, determining whether the individual Y obtained at step S7 conforms to a tabu rule in a tabu list TSList; if yes, performing step S10; otherwise, performing step S11;

S10, updating the candidate solution set List (Xₛ), moving the individual Y out of the set List (Xₛ), and returning to the step S7;

S11, determining whether a new individual Y is obtained; and if the individual Y is updated, assigning Y to Xₛ;

S12, updating the tabu list TSList according to the initial solution Xₛ; and

S13, assigning I+1 to I, determining whether I≤Iₘₐₓ is true, and if yes, returning to the step S6; otherwise, terminating the execution of the algorithm.

The at least one output unit is configured to output a fitness value of the optimal solution X_{best}, a batching scheme of jobs in the job set and an assignment scheme of job batches to each processing machine.

As described above, implemented through loading and execution of the at least one instruction by the at least one processing unit, the process of setting the initial solution of the algorithm Xₛ={x₁, . . . , x_{d}, . . . , xₗ} includes:

step S51, sorting all batches in the batch set B={b₁, . . . , b_{d}, . . . , bₗ} in non-increasing order by processing length, thereby forming a sorted batch set denoted as B′{b′₁, . . . , b′_{d}, . . . , b′ₗ};

step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;

step S53, defining variables d=1 and k=1;

step S54, assigning Mₖ to x_{d};

step S55, assigning k+1 to k, and determining whether k≤m is true; if yes, performing step S56; otherwise, letting k=1, and performing step S56; and

step S56, assigning d+1 to d, and determining whether d≤1 is true; if yes, returning to the step S54; otherwise, taking X={x₁, . . . , x_{d}, . . . , xₗ} as the initial solution Xₛ.

In a third aspect, the present invention provides a computer-readable storage medium that stores at least one instruction to be loaded and executed by a processor to implement the above method.

The embodiments of the present invention provide a coordinated production and transportation scheduling method and system based on an improved tabu search algorithm. The method is mainly aimed at the coordinated production and transportation batch scheduling problem with multiple manufacturers, and by obtaining a near-optimal solution for this problem, i.e., developing a scientific, effective coordinated production and transportation scheduling scheme, the whole profit of an enterprise in the production and transportation phases can be maximized, and high quality services can be provided for customers of the enterprise with improved core competitiveness of the enterprise.

### BRIEF DESCRIPTION OF THE DRAWINGS

Various other advantages and benefits will become obvious for those of ordinary skill in the art from the following detailed descriptions of preferred embodiments. The accompanying drawings are merely intended to illustrate the preferred embodiments rather than limit the invention. Furthermore, like reference numerals indicate like components throughout the drawings in which:

FIG. 1 is a flowchart of a coordinated production and transportation scheduling method based on an improved tabu search algorithm in accordance with an embodiment of the present invention; and

FIG. 2 is a structure diagram of a coordinated production and transportation scheduling system based on an improved tabu search algorithm in accordance with an embodiment of the present invention.

### DETAILED DESCRIPTION OF THE PRESENT INVENTION

Technical solutions in the embodiments of the present invention will be described clearly and fully below in combination with the drawings accompanying the embodiments of the present invention. It is apparent that the described embodiments are merely part of embodiments of the present invention, rather than all. Other embodiments achieved by those of ordinary skill in the art based on the embodiments in the present invention without creative work shall all fall into the scope of protection of the present invention.

The embodiments of the present invention are meant to solve the coordinated production and transportation batch scheduling problem with uniform parallel machines under the circumstance of manufactures with distributed uniform machines, and the optimization objective of the problem is to minimize makespan. Based on the characteristics of the problem, an effective algorithm is developed to solve the combinatorial optimization problem, allowing for maximization of the whole profit in coordinated production and transportation.

For convenience of understanding, the problems to be solved by the embodiments of the present invention are explained in detail first below.

(1) There are n jobs needing to be processed during the execution of a production task, with the set of jobs being denoted as J={J₁, . . . , Jᵢ, . . . , Jₙ}, the size of job Jᵢ denoted as Sᵢ and the processing length denoted as Pᵢ.

(2) The jobs in the job set J need to be transported to m processing machines located in different geographical positions for processing, with the capacity of each processing machine being the same and denoted as C, the processing speed of processing machine k denoted as vₖ, the transportation time needed for a job to arrive at machine k denoted as rₖ.

(3) The completion time of a batch on a processing machine is decided by the job with the longest completion time in the batch, and it is prohibited to add a new job to a batch and remove a job out of this batch before the completion of processing of the batch.

(4) A set of job batches assigned to processing machine k is denoted as Bₖ. The completion time Cₖ of the machine k is decided by the last batch. The completion time C_{b}_{ₖⱼ} of the current batch bₖⱼ is equal to the sum of the completion time of the previous batch and the processing time of the current batch, i.e., C_{b}_{ₖⱼ}=C_{b}_{_{kj−1}}+P_{b}_{ₖⱼ}/vₖ. The completion time Cₖ of machine k is decided by the last

Cₖ=max{C_{b}_{ₖⱼ}|bₖⱼ ∈Bₖ}+rₖ.

processed batch, i.e.,

(5) After the completion of processing of jobs on each machine, the jobs must be transported to the customer. The time needed for the jobs on machine k to arrive at the customer is denoted as Tₖ. The optimization objective of the problem is the makespan from the start of the production task to final delivery to the customer Cₘₐₓ=max{Cₖ+Tₖ|k=1, . . . , m}.

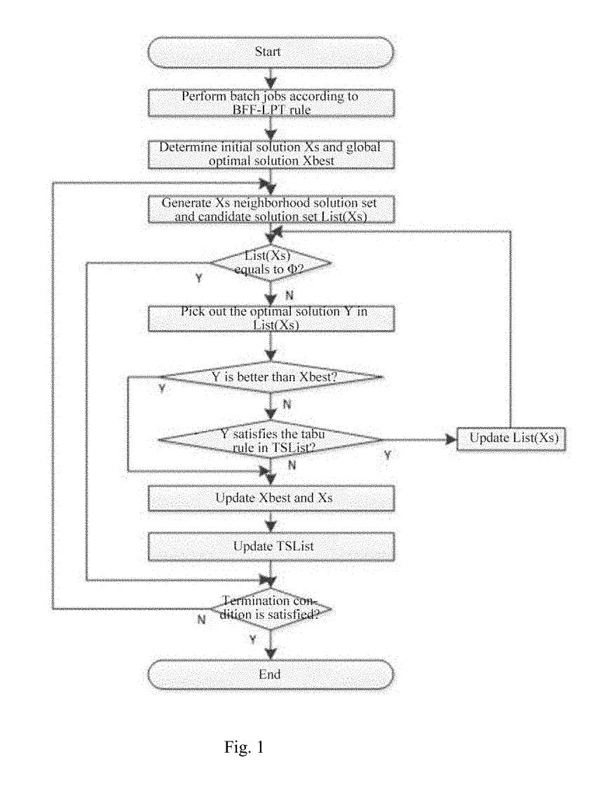

On this basis, one embodiment of the present invention provides a coordinated production and transportation scheduling method based on an improved tabu search algorithm. The method is executed by a computer, as shown in FIG. 1, and includes:

S1, sorting all jobs in a job set J={J₁, . . . , Jᵢ, . . . , Jₙ} in non-increasing order by basic processing time, thereby obtaining a sorted job set J′={J′₁, . . . , J′ᵢ, . . . , J′ₙ};

S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;

S3, repeating the step S2 until all jobs of the job set J′ are assigned to corresponding batches, thereby forming a batch set denoted as B={b₁, . . . , b_{d}, . . . , bₗ};

S4, initializing input parameters of the algorithm, the input parameters including number of jobs n, job size s, basic processing time of a job p, number of processing machines m, time needed for a job to arrive at a processing machine r, maximum number of jobs that each batch is capable of holding C and processing speed v, as well as time needed for transporting jobs from each processing machine T;

S5, setting execution parameters of the algorithm, the execution parameters including maximum iterations Iₘₐₓ, current iteration I=1, crossover probability CR, and initial solution of the algorithm Xₛ={x₁, . . . , x_{d}, . . . , xₗ}, wherein x_{d} represents that the dth batch is assigned to machine x_{d}, with the global optimal solution X_{best}=Xₛ;

S6, generating a neighborhood solution set N (Xₛ) according to the initial solution Xₛ, updating individuals in N(Xₛ), and determining a candidate solution set List(Xₛ);

S7, determining whether List(Xₛ) is a null set; if yes, performing step S12; otherwise, picking out the optimal individual Y from List(Xₛ);

S8, determining whether the individual Y is better than the global optimal solution X_{best}; if yes, assigning Y to X_{best} and performing step S11; otherwise, performing step S9;

S9, determining whether the individual Y obtained at step S7 conforms to a tabu rule in a tabu list TSList; if yes, performing step S10; otherwise, performing step S11;

S10, updating the candidate solution set List(Xₛ)), moving the individual Y out of the set List(Xₛ), and returning to the step S7;

S11, determining whether a new individual Y is obtained; and if the individual Y is updated, assigning Y to Xₛ;

S12, updating the tabu list TSList according to the initial solution Xₛ; and

S13, assigning I+1 to I, determining whether I≤Iₘₐₓ is true, and if yes, returning to the step S6; otherwise, terminating the execution of the algorithm, and outputting a fitness value of the optimal solution X_{best}, a batching scheme of jobs in the job set and an assignment scheme of job batches to each processing machine.

The present invention is mainly aimed at the coordinated production and transportation batch scheduling problem with multiple manufacturers. By obtaining a near-optimal solution for this problem, i.e., developing a scientific, effective coordinated production and transportation scheduling scheme, the whole profit of an enterprise in the production and transportation phases can be maximized, and high quality services can be provided for customers of the enterprise with improved core competitiveness of the enterprise.

In specific implementation, setting the initial solution of the algorithm Xₛ={x₁, . . . , x_{d}, . . . , xₗ} in the step S5 may specifically include:

step S51, sorting all batches in the batch set B={b₁, . . . , b_{d}, . . . , bₗ} in non-increasing order by processing length, thereby forming a sorted batch set denoted as B′{b′₁, . . . , b′_{d}, . . . , b′ₗ};

step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;

step S53, defining variables d=1 and k=1;

step S54, assigning Mₖ to x_{d};

step S55, assigning k+1 to k, and determining whether k≤m is true; if yes, performing step S56; otherwise, letting k=1, and performing step S56; and

step S56, assigning d+1 to d, and determining whether d≤1 is true; if yes, returning to the step S54; otherwise, taking X={x₁, . . . , x_{d}, . . . , xₗ} as the initial solution Xₛ.

In specific implementation, the step S6, i.e., generating the neighborhood solution set N(Xₛ) according to the initial solution Xₛ, updating the individuals in N(Xₛ), and determining the candidate solution set List(Xₛ), may specifically include:

step S61, generating the neighborhood solution set with consideration of total W individuals in the neighborhood solution, and denoting the solution set as N(Xₛ)={X₁, . . . , Xⱼ, . . . , X_{W}}, wherein Xⱼ represents the jth individual among the neighborhood solutions, and the individual is obtained by randomly swapping the initial solution Xₛ for I times;

step S62, defining variable N (Xₛ)={X′₁, . . . , X′ⱼ, . . . , X′_{W}}, which has the same meaning as N(Xₛ), and assigning the individuals in N(Xₛ) to N′(Xₛ); and letting variable j=1;

step S63, randomly generating random numbers denoted as index1 and index2 in the range of an interval [1, W], with index1, index2 and j differing from one another;

step S64, defining variables Vⱼ and Uⱼ, with Vⱼ and Uⱼ being in the same dimension with the individual Xⱼ; letting variable d=1; generating a random number random in the range of an interval (0,1], and assigning the random number to variable F;

step S65, updating V_{jd} by equation V_{jd}=X_{bd}+F×(X_{index1d}−X_{index2d}), wherein X_{bd} representing the dth element in the global optimal solution;

step S66, randomly generating a random number rand in the range of the interval (0,1], and determining whether rand≤CR is true; if yes, assigning V_{jd} to U_{jd}; otherwise, assigning X_{jd} to U_{jd};

step S67, assigning d+1 to d, and determining whether d≤l is true; if yes, returning to the step S65; otherwise, performing step S68;

step S68, calculating fitness values F(X′ⱼ) and F(Uⱼ) of individual X′ⱼ and intermediate Uⱼ, and comparing F(X′ⱼ) with F(Uⱼ); if F(X′ⱼ)≤F(Uⱼ), assigning Uⱼ to the individual Xⱼ;

step S69, assigning j+1 to j, and determining whether j≤W is true; if yes, returning to the step S63; otherwise, performing step S610; and

step S610, considering Q individuals in the candidate solution set which is denoted as List(Xₛ), sorting the W individuals in N(Xₛ) in non-decreasing order by fitness value, picking out first Q individuals from the sequence, and assigning the chosen Q to List(Xₛ).

In specific implementation, updating the tabu list TSList according to the initial solution Xₛ in the step S12 may specifically include:

step S121, determining a job batch set Bₖ on the kth machine according to the initial solution Xₛ;

step S122, picking out ┌|Bₖ|/2┐ job batches from Bₖ to form a batch set B′ₖ, wherein variable |Bₖ| represents the number of job sets in the set Bₖ;

step S123, repeating the step S122 until each machine has a chosen set, thereby forming a tabu list element denoted as S={B′₁, . . . , B′ₖ, . . . , B′ₘ};

step S124, determining whether S is identical to all existing elements of the tabu list, and if an element is identical to S, returning to the step S122; and

step S125, inserting S into the tabu list, and then removing the first element inserted in the tabu list.

In specific implementation, outputting the fitness value of an individual in the step S13 may specifically include:

step S131, traversing all elements in individual X={x₁, . . . , x_{d}, . . . , xₗ}, and defining variable d=1, with variable Bₖ representing a set of job batches assigned to the kth machine, and variable |Bₖ| representing the number of job batches in the set Bₖ;

step S132, determining whether l≤x_{d}≤m is satisfied; if no, performing step S133; otherwise, performing step S134;

step S133, generating a random integer denoted as random in the range of an interval [1, m], and assigning random to x_{d};

step S134, determining whether x_{d}=k is true, wherein k ∈ {1, . . . , m}, and if yes, placing b_{d} into Bₖ;

step S135, assigning d+1 to d, and determining whether d≤l is true; if yes, returning to the step S132; otherwise, performing step S136;

step S136, defining variable k=1;

step S137, defining variables j=1 and Cₖ=0, wherein Cₖ represents the completion time of the kth machine;

step S138, assigning C_{b}_{ₖⱼ}=C_{b}_{_{kj−1}}+P_{b}_{ₖⱼ}/vₖ to Cₖ;

step S139, assigning j+1 to j, and determining whether j≤|Bₖ| is true; if yes, returning to the step S138; otherwise, assigning Cₖ+rₖ+Tₖ to Cₖ;

step S1310, assigning k+1 to k, and determining whether k≤|Bₖ| is true; if yes, returning to the step S137; otherwise, obtaining a set of makespans of all machines denoted as C*={C₁, . . . , Cₖ, . . . , Cₘ}; and

step S1311, picking out the maximum element from the makespan set C* obtained in the step 1310, and assigning the element to Cₘₐₓ, i.e., Cₘₐₓ=max{C₁, . . . , Cₖ, . . . , Cₘ}, wherein variable Cₘₐₓ represents the fitness value of the individual X.

The present invention has the following advantages:

1. The present invention is aimed at the coordinated production and transportation batch scheduling problem with distributed uniform parallel machines. By the improved tabu search algorithm, processing machines are coded first, and various batches established according to a heuristic rule are assigned to such machines. Then, a corresponding production scheduling scheme is developed, and fitness values of corresponding individuals are calculated. During the generation of the neighborhood solution set, operations such as mutation, crossover and selection are performed on the individuals of the population to update the individuals, thereby improving the quality of candidate solutions. Next, the candidate solutions and the tabu list are updated according to the chosen optimal individual. The above steps are repeated to achieve algorithm iterations, thereby obtaining the optimal solution searched for by the algorithm, i.e., the optimal production scheduling scheme. The improved tabu search algorithm exhibits good performance in convergence rate and quality of solution. By this algorithm, the coordinated production and transportation batch scheduling problem with distributed uniform machines is solved, so that the productivity of an enterprise can be improved, and the existing social production resources can be fully utilized.

2. According to the present invention, during the generation of neighborhood solutions, a search population is generated according to an initial solution first, and then operations such as mutation, crossover and selection are performed on the individuals of the population based on a differential evolution algorithm, thereby improving the quality of the individuals of the population with guaranteed diversity of the population. The tabu objects in the tabu list are job batches assigned to machines and repeated assignment of the same job batch set to a machine is avoided. As a result, it is helpful for the algorithm to step out the local optimal solution, thereby guaranteeing the convergence capability of the algorithm.

3. During the mutation operation process based on the differential evolution algorithm, the intermediate of mutation is determined jointly by the global optimal solution and a random individual of the population, so that both the inheritance of excellent individuals and the diversity of mutation are guaranteed in the mutation search process, allowing for expansion of the search space of the population.

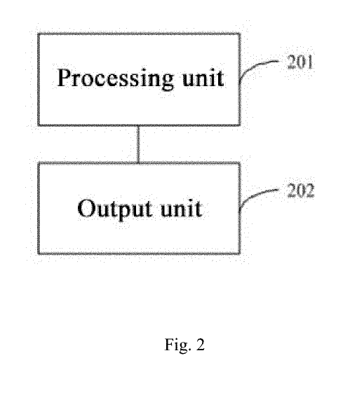

Based on the same inventive concept, another embodiment of the present invention provides a coordinated production and transportation scheduling system based on an improved tabu search algorithm. As shown in FIG. 2, the scheduling system includes a computer including:

at least one storage unit 201;

at least one processing unit 202; and

at least one output unit (not shown in the figure);

wherein the processing unit may be, for example, a processor. The storage unit may be, for example, a memory. The output unit may be, for example, an output device formed by a data interface and a data cable. The output unit can output data to a display screen, other electronic devices and the like;

wherein the at least one storage unit stores at least one instruction to be loaded and executed by the at least one processing unit to implement the following steps:

S1, sorting all jobs in a job set J={J₁, . . . , Jᵢ, . . . , Jₙ} in non-increasing order by basic processing time, thereby obtaining a sorted job set J′={J′₁, . . . , J′ᵢ, . . . , J′ₙ};

S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;

S3, repeating the step S2 until all jobs of the job set J′ are assigned to corresponding batches, thereby forming a batch set denoted as B={b₁, . . . , b_{d}, . . . , bₗ};

S4, initializing input parameters of the algorithm, the input parameters including number of jobs n, job size s, basic processing time of a job p, number of processing machines m, time needed for a job to arrive at a processing machine r, maximum number of jobs that each batch is capable of holding C and processing speed v, as well as time needed for transporting jobs from each processing machine T;

S5, setting execution parameters of the algorithm, the execution parameters including maximum iterations Iₘₐₓ, current iteration I=1, crossover probability CR, and initial solution of the algorithm Xₛ={x₁, . . . , x_{d}, . . . , xₗ}, wherein x_{d} represents that the dth batch is assigned to machine x_{d}, with the global optimal solution X_{best}=Xₛ;

S6, generating a neighborhood solution set N(Xₛ) according to the initial solution Xₛ, updating individuals in N(Xₛ), and determining a candidate solution set List(Xₛ);

S7, determining whether List(Xₛ) is a null set; if yes, performing step S12; otherwise, picking out the optimal individual Y from List (Xₛ);

S8, determining whether the individual Y is better than the global optimal solution X_{best}; if yes, assigning Y to X_{best} and performing step S11; otherwise, performing step S9;

S9, determining whether the individual Y obtained at step S7 conforms to a tabu rule in a tabu list TSList; if yes, performing step S10; otherwise, performing step S11;

S10, updating the candidate solution set List(Xₛ), moving the individual Y out of the set List(Xₛ), and returning to the step S7;

S11, determining whether a new individual Y is obtained; and if the individual Y is updated, assigning Y to Xₛ;

S12, updating the tabu list TSList according to the initial solution Xₛ; and

S13, assigning I+1 to I, determining whether I≤Iₘₐₓ is true, and if yes, returning to the step S6; otherwise, terminating the execution of the algorithm.

The at least one output unit 202 is configured to output a fitness value of the optimal solution best X_{best}, a batching scheme of jobs in the job set and an assignment scheme of job batches to each processing machine.

Alternatively, the at least one processing unit 201 sets the initial solution of the algorithm Xₛ−{x₁, . . . , x_{d}, . . . , xₗ} in the step S5, which may specifically include:

step S51, sorting all batches in the batch set B={b₁, . . . , b_{d}, . . . , bₗ} in non-increasing order by processing length, thereby forming a sorted batch set denoted as B′−{b′₁, . . . , b′_{d}, . . . , b′ₗ};

step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;

step S53, defining variables d=1 and k=1;

step S54, assigning Mₖ to x_{d};

step S55, assigning k+1 to k, and determining whether k is true; if yes, performing step S56; otherwise, letting k=1, and performing step S56; and

step S56, assigning d+1 to d, and determining whether d≤1 is true; if yes, returning to the step S54; otherwise, taking X={x₁, . . . , x_{d}, . . . , xₗ} as the initial solution Xₛ.

Alternatively, the at least one processing unit 201 generates the neighborhood solution set N(Xₛ) according to the initial solution Xₛ, updates the individuals in N(Xₛ) and determines the candidate solution set List(Xₛ) in the step S6, which may specifically include:

step S61, generating the neighborhood solution set with consideration of total W individuals in the neighborhood solution, and denoting the solution set as N(Xₛ)={X₁, . . . , Xⱼ, . . . , X_{W}}, wherein Xⱼ represents the jth individual among the neighborhood solutions, and the individual is obtained by randomly swapping the initial solution Xₛ for I times;

step S62, defining variable N′(Xₛ)={X′₁, . . . , X′ⱼ, . . . , X′_{W}}, which has the same meaning as N(Xₛ), and assigning the individuals in N(Xₛ) to N′ (Xₛ); and letting variable j=1;

step S63, randomly generating random numbers denoted as index1 and index2 in the range of an interval [1, W], with index1, index2 and j differing from one another;

step S64, defining variables Vⱼ and Uⱼ, with Vⱼ and Uⱼ being in the same dimension with the individual Xⱼ; letting variable d=1; generating a random number random in the range of an interval (0,1], and assigning the random number to variable F;

step S65, updating V_{jd} by equation V_{jd}=X_{bd}+F×(X_{index1d}−X_{index2d}), wherein X_{bd} representing the dth element in the global optimal solution;

step S66, randomly generating a random number rand in the range of the interval (0,1], and determining whether rand≤CR is true; if yes, assigning V_{jd} to U_{jd}; otherwise, assigning X_{jd} to U_{jd};

step S67, assigning d+1 to d, and determining whether d≤l is true; if yes, returning to the step S65; otherwise, performing step S68;

step S68, calculating fitness values F(X′ⱼ) and F(Uⱼ) of individual X′ⱼ and intermediate Uⱼ, and comparing F(X′ⱼ) with F(Uⱼ); if F(X′ⱼ)≤F(Uⱼ), assigning Uⱼ to the individual Xⱼ;

step S69, assigning j+1 to j, and determining whether j≤W is true; if yes, returning to the step S63; otherwise, performing step S610; and

step S610, considering Q individuals in the candidate solution set which is denoted as List(Xₛ), sorting the W individuals in N(Xₛ) in non-decreasing order by fitness value, picking out first Q individuals from the sequence, and assigning the chosen Q to List(Xₛ).

Alternatively, the at least one processing module 201 updates the tabu list TSList according to the initial solution Xₛ in the step 12, which may specifically include:

step S121, determining a job batch set Bₖ on the kth machine according to the initial solution Xₛ;

step S122, picking out ┌|Bₖ|/2┐ job batches from Bₖ to form a batch set B′ₖ, wherein variable |Bₖ| represents the number of job sets in the set Bₖ;

step S123, repeating the step S122 until each machine has a chosen set, thereby forming a tabu list element denoted as S={B′₁, . . . , B′ₖ, . . . , B′ₘ};

step S124, determining whether S is identical to all existing elements of the tabu list, and if an element is identical to S, returning to the step S122; and

step S125, inserting S into the tabu list, and then removing the first element inserted in the tabu list.

Alternatively, the at least one processing module outputs the fitness value of an individual in the step S13, which may specifically include:

step S131, traversing all elements in individual X={x₁, . . . , x_{d}, . . . , xₗ}, and defining variable d=1, with variable Bₖ representing a set of job batches assigned to the kth machine, and variable |Bₖ| representing the number of job batches in the set Bₖ;

step S132, determining whether 1≤x_{d}≤m is satisfied; if no, performing step S133; otherwise, performing step S134;

step S133, generating a random integer denoted as random in the range of an interval [1, m], and assigning random to x_{d};

step S134, determining whether x_{d}=k is true, wherein k ∈ {1, . . . , m}, and if yes, placing b_{d} into Bₖ;

step S135, assigning d−1 to d, and determining whether d≤l is true; if yes, returning to the step S132; otherwise, performing step S136;

step S136, defining variable k=1;

step S137, defining variables j=1 and Cₖ=0, wherein Cₖ represents the completion time of the kth machine;

step S138, assigning C_{b}_{ₖⱼ}=C_{b}_{_{kj 1}}+P_{b}_{ₖⱼ}/vₖ to Cₖ;

step S139, assigning j+1 to j, and determining whether j≤|Bₖ| is true; if yes, returning to the step S138; otherwise, assigning Cₖ+rₖ+Tₖ to Cₖ;

step S1310, assigning k+1 to k, and determining whether k≤|Bₖ| is true; if yes, returning to the step S137; otherwise, obtaining a set of makespans of all machines denoted as C*={C₁, . . . , Cₖ, . . . , Cₘ}; and

step S1311, picking out the maximum element from the makespan set C* obtained in the step 1310, and assigning the element to Cₘₐₓ, i.e., Cₘₐₓ=max{C₁, . . . , Cₖ, . . . , Cₘ}, wherein variable Cₘₐₓ represents the fitness value of the individual X.

Since the coordinated production and transportation scheduling system based on the improved tabu search algorithm introduced in this embodiment can execute the coordinated production and transportation scheduling method based on the improved tabu search algorithm according to the embodiment of the present invention, those skilled in the art can understand specific embodiments of the coordinated production and transportation scheduling system based on the improved tabu search algorithm according to this embodiment and various variations thereof on the basis of the coordinated production and transportation scheduling method based on the improved tabu search algorithm introduced in the embodiment of the present invention. Thus, how the coordinated production and transportation scheduling system based on the improved tabu search algorithm implements the coordinated production and transportation scheduling method based on the improved tabu search algorithm in the embodiment of the present invention will not be introduced in detail herein. Any implementation of the system employed in the coordinated production and transportation scheduling method based on the improved tabu search algorithm in the embodiment of the present invention by those skilled in the art shall fall into the scope of protection of the present application.

An embodiment of the present invention also provides a computer-readable storage medium that stores at least one instruction to be loaded and executed by a processor to implement the above scheduling method.

Numerous specific details are provided in the description herein. However, it can be understood that the embodiments of the present disclosure may be practiced without these specific details. In some examples, well-known methods, structures and techniques are not shown in detail in order not to obscure the understanding of this description.

Similarly, it should be appreciated that in the foregoing descriptions of the example embodiments of the present disclosure, various features of the present invention are sometimes grouped together in a single embodiment, figure, or description thereof for the purpose of streamlining the disclosure and aiding in the understanding of one or more of the various inventive aspects. However, the method of the present disclosure is not to be interpreted as reflecting an intention that the claimed invention requires more features that are expressly contained in each claim. Rather, as the following claims reflect, inventive subject matter lies in less than all features of a single embodiment as disclosed above. Thus, the claims following the detailed description are hereby expressly incorporated into the detailed description, with each claim standing on its own as a separate embodiment of the present disclosure.

What is claimed is:

1. A coordinated production and transportation scheduling method based on an improved tabu search algorithm, the method being executed by a computer and comprising:
S1, sorting all jobs in a job set J={J₁, . . . , Jᵢ, . . . , Jₙ} in non-increasing order by basic processing time, thereby obtaining a sorted job set J′={J′₁, . . . , J′ᵢ, . . . , J′ₙ}, wherein Jᵢ represents the ith job in the job set, and J′ᵢ represents the ith job in the sorted job set;
S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;
S3, repeating the step S2 until all jobs of the job set J′ are assigned to corresponding batches, thereby forming a batch set denoted as B={b₁, . . . , b_{d}, . . . , bₗ}, wherein b_{d} represents the dth batch, and l represents the number of batches;
S4, initializing input parameters of the algorithm, the input parameters including number of jobs n, job size s, basic processing time of a job p, number of processing machines m, time needed for a job to arrive at a processing machine r, maximum number of jobs that each batch is capable of holding C and processing speed v, as well as time needed for transporting jobs from each processing machine T;
S5, setting execution parameters of the algorithm, the execution parameters including maximum iterations Iₘₐₓ, current iteration I=1, crossover probability CR, and initial solution of the algorithm Xₛ={x₁, . . . , x_{d}, . . . , xₗ}, wherein x_{d} represents that the dth batch is assigned to machine x_{d}, with the global optimal solution X_{best}=Xₛ;
S6, generating a neighborhood solution set N(Xₛ) according to the initial solution Xₛ, updating individuals in N(Xₛ), and determining a candidate solution set List(Xₛ);
S7, determining whether List(Xₛ) is a null set; if yes, performing step S12; otherwise, picking out the optimal individual Y from List(Xₛ);
S8, determining whether the individual Y is better than the global optimal solution X_{best}; if yes, assigning Y to X_{best} and performing step S11; otherwise, performing step S9;
S9, determining whether the individual Y obtained at step S7 conforms to a tabu rule in a tabu list TSList; if yes, performing step S10; otherwise, performing step S11;
S10, updating the candidate solution set List(Xₛ), moving the individual Y out of the set List(Xₛ), and returning to the step S7;
S11, determining whether a new individual Y is obtained; and if the individual Y is updated, assigning Y to Xₛ;
S12, updating the tabu list TSList according to the initial solution Xₛ; and
S13, assigning I+1 to I, determining whether I≤Iₘₐₓ is true, and if yes, returning to the step S6; otherwise, terminating the execution of the algorithm, and outputting a fitness value of the optimal solution X_{best}, a batching scheme of jobs in the job set and an assignment scheme of job batches to each processing machine;
wherein setting the initial solution of the algorithm Xₛ={x₁, . . . , x_{d}, . . . , xₗ} in the step S5 comprises:
step S51, sorting all batches in the batch set B={b₁, . . . , b_{d}, . . . , bₗ} in non-increasing order by processing length, thereby forming a sorted batch set denoted as B′={b′₁, . . . , b′_{d}, . . . , b′ᵢ};
step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;
step S53, defining variables d=1 and k=1;
step S54, assigning Mₖ to x_{d};
step S55, assigning k+1 to k, and determining whether k≤m is true; if yes, performing step S56; otherwise, letting k=1, and performing step S56; and
step S56, assigning d+1 to d, and determining whether d≤l is true; if yes, returning to the step S54; otherwise, taking X−{x₁, . . . , x_{d}, . . . , xₗ} as the initial solution Xₛ.

2. The method according to claim 1, wherein the step S6, i.e., generating the neighborhood solution set N(Xₛ) according to the initial solution Xₛ, updating the individuals in N(Xₛ), and determining the candidate solution set List(Xₛ), specifically comprises:
step S61, generating the neighborhood solution set with consideration of total W individuals in the neighborhood solution, and denoting the solution set as N(Xₛ)={X₁, . . . , Xⱼ, . . . , X_{W}}, wherein Xⱼ represents the jth individual among the neighborhood solutions, and the individual is obtained by randomly swapping the initial solution Xₛ for l times;
step S62, defining variable N′ (Xₛ)−{X′₁, . . . , X′ⱼ, . . . , X′_{W}}, which has the same meaning as N(Xₛ), and assigning the individuals in N(Xₛ) to N′(Xₛ); and letting variable j=1;
step S63, randomly generating random numbers denoted as index1 and index2 in the range of an interval [1, W], with index1, index2 and j differing from one another;
step S64, defining variables Vⱼ and Uⱼ, with Vⱼ and Uⱼ being in the same dimension with the individual Xⱼ; letting variable d=1; generating a random number random in the range of an interval (0,1], and assigning the random number to variable F;
step S65, updating V_{jd} by equation V_{jd}=X_{bd}+F×(X_{index1d}−X_{index2d}), wherein X_{bd} representing the dth element in the global optimal solution;
step S66, randomly generating a random number rand in the range of the interval (0,1], and determining whether rand≤CR is true; if yes, assigning V_{jd} to U_{jd}; otherwise, assigning X_{jd} to U_{jd};
step S67, assigning d+1 to d, and determining whether d≤l is true; if yes, returning to the step S65; otherwise, performing step S68;
step S68, calculating fitness values F(X′ⱼ) and F(Uⱼ) of individual X′ⱼ and intermediate Uⱼ, and comparing F(X′ⱼ) with F(Uⱼ); if F(X′ⱼ)≤F(Uⱼ), assigning Uⱼ to the individual Xⱼ;
step S69, assigning j+1 to j, and determining whether j≤W is true; if yes, returning to the step S63; otherwise, performing step S610; and
step S610, considering Q individuals in the candidate solution set which is denoted as List (Xₛ), sorting the W individuals in N(Xₛ) in non-decreasing order by fitness value, picking out first Q individuals from the sequence, and assigning the chosen Q to List (Xₛ).

3. The method according to claim 1, wherein updating the tabu list TSList according to the initial solution Xₛ in the step S12 comprises:
step S121, determining a job batch set Bₖ on the kth machine according to the initial solution Xₛ;
step S122, picking out ┌|Bₖ|/2┐ job batches from Bₖ to form a batch set B′ₖ, wherein variable |Bₖ| represents the number of job sets in the set Bₖ;
step S123, repeating the step S122 until each machine has a chosen set, thereby forming a tabu list element denoted as S={B′₁, . . . , B′ₖ, . . . , B′ₘ};
step S124, determining whether S is identical to all existing elements of the tabu list, and if an element is identical to S, returning to the step S122; and
step S125, inserting S into the tabu list, and then removing the first element inserted in the tabu list.

4. The method according to claim 1, wherein outputting the fitness value of an individual in the step S13 comprises:
step S131, traversing all elements in individual X={x₁, . . . , x_{d}, . . . , xₗ}, and defining variable d=1, with variable Bₖ representing a set of job batches assigned to the kth machine, and variable |Bₖ| representing the number of job batches in the set Bₖ;
step S132, determining whether 1≤x_{d}≤m is satisfied; if no, performing step S133; otherwise, performing step S134;
step S133, generating a random integer denoted as random in the range of an interval [1, m], and assigning random to x_{d};
step S134, determining whether x_{d}=k is true, wherein k ∈ {1, . . . , m}, and if yes, placing b_{d} into Bₖ;
step S135, assigning d+1 to d, and determining whether d≤l is true; if yes, returning to the step S132; otherwise, performing step S136;
step S136, defining variable k=1;
step S137, defining variables j=1 and Cₖ=0, wherein Cₖ represents the completion time of the kth machine;
step S138, assigning C_{b}_{ₖⱼ}=C_{b}_{_{kj−1}}+P_{b}_{ₖⱼ}/vₖ to Cₖ, wherein P_{b}_{ₖⱼ} represents the processing time of the jth batch on the kth machine;
step S139, assigning j+1 to j, and determining whether j≤|Bₖ| is true; if yes, returning to the step S138; otherwise, assigning Cₖ+rₖ+Tₖ to Cₖ;
step S1310, assigning k+1 to k, and determining whether k≤|Bₖ| is true; if yes, returning to the step S137; otherwise, obtaining a set of makespans of all machines denoted as C*{C₁, . . . , Cₖ, . . . , Cₘ}; and
step S1311, picking out the maximum element from the makespan set C* obtained in the step 1310, and assigning the element to Cₘₐₓ, i.e., Cₘₐₓ=max{C₁, . . . , Cₖ, . . . , Cₘ}, wherein variable Cₘₐₓ represents the fitness value of the individual X.

5. A coordinated production and transportation scheduling system based on an improved tabu search algorithm, wherein the system comprises a computer, comprising:
at least one storage unit;
at least one processing unit; and
at least one output unit;
wherein the at least one storage unit stores at least one instruction to be loaded and executed by the at least one processing unit to implement the following steps:
S1, sorting all jobs in a job set J−{J₁, . . . , Jᵢ, . . . , Jₙ} in non-increasing order by basic processing time, thereby obtaining a sorted job set J′={J′₁, . . . , J′ᵢ, . . . , J′ₙ}, wherein Jᵢ represents the ith job in the job set, and J′ᵢ represents the ith job in the sorted job set;
S2, picking out all batches that are capable of holding a first unassigned job from existing batches according to the job set J′, obtaining the batch with the smallest free space from the chosen batches, placing the first unassigned job of J′ into the finally chosen batch, and deleting the job from a job list;
S3, repeating the step S2 until all jobs of the job set J′ are assigned to corresponding batches, thereby forming a batch set denoted as B={b₁, . . . , b_{d}, . . . , bₗ}, wherein b_{d} represents the dth batch, and l represents the number of batches;
S4, initializing input parameters of the algorithm, the input parameters including number of jobs n, job size s, basic processing time of a job p, number of processing machines m, time needed for a job to arrive at a processing machine r, maximum number of jobs that each batch is capable of holding C and processing speed v, as well as time needed for transporting jobs from each processing machine T;
S5, setting execution parameters of the algorithm, the execution parameters including maximum iterations Iₘₐₓ, current iteration I−1, crossover probability CR, and initial solution of the algorithm Xₛ{x₁, . . . , x_{d}, . . . , xₗ}, wherein x_{d} represents that the dth batch is assigned to machine x_{d}, with the global optimal solution X_{best}=Xₛ;
S6, generating a neighborhood solution set N(Xₛ) according to the initial solution Xₛ, updating individuals in N(Xₛ), and determining a candidate solution set List(Xₛ);
S7, determining whether List(Xₛ) is a null set; if yes, performing step S12; otherwise, picking out the optimal individual Y from List(Xₛ);
S8, determining whether the individual Y is better than the global optimal solution X_{best}; if yes, assigning Y to X_{best} and performing step S11; otherwise, performing step S9;
S9, determining whether the individual Y obtained at step S7 conforms to a tabu rule in a tabu list TSList; if yes, performing step S10; otherwise, performing step S11;
S10, updating the candidate solution set List (Xₛ)), moving the individual Y out of the set List(Xₛ), and returning to the step S7;
S11, determining whether a new individual Y is obtained; and if the individual Y is updated, assigning Y to Xₛ;
S12, updating the tabu list TSList according to the initial solution Xₛ; and
S13, assigning I+1 to I, determining whether I≤Iₘ, is true, and if yes, returning to the step S6; otherwise, terminating the execution of the algorithm;
the at least one output unit is configured to output and outputting a fitness value of the optimal solution X_{best}, a batching scheme of jobs in the job set and an assignment scheme of job batches to each processing machine;
wherein in the step S5 implemented through loading and execution of the at least one instruction by the at least one processing unit, the process of setting the initial solution of the algorithm Xₛ={x₁, . . . , x_{d}, . . . , xₗ} comprises:
step S51, sorting all batches in the batch set B={b₁, . . . , b_{d}, . . . , bₗ} in non-increasing order by processing length, thereby forming a sorted batch set denoted as B′={b′₁, . . . , b′_{d}, . . . , b′ₗ};
step S52, sorting machines in non-increasing order by processing speed, thereby obtaining a sorted machine set M={M₁, . . . , Mₖ, . . . , Mₘ}, with Mₖ representing the processing machine which has a processing speed in the kth place and which is numbered as Mₖ;
step S53, defining variables d=1 and k=1;
step S54, assigning Mₖ to x_{d};
step S55, assigning k+1 to k, and determining whether k≤m is true; if yes, performing step S56; otherwise, letting k=1, and performing step S56; and
step S56, assigning d+1 to d, and determining whether d≤l is true; if yes, returning to the step S54; otherwise, taking X={x₁, . . . , x_{d}, . . . , xₗ} as the initial solution Xₛ.

6. The system according to claim 5, wherein in the step S6 implemented through loading and execution of the at least one instruction by the at least one processing unit, the process of generating the neighborhood solution set N(Xₛ) according to the initial solution Xₛ, updating the individuals in N(Xₛ) and determining the candidate solution set List(Xₛ) comprises:
step S61, generating the neighborhood solution set with consideration of total W individuals in the neighborhood solution, and denoting the solution set as N(Xₛ)={X₁, . . . , Xⱼ, . . . , X_{W}}, wherein Xⱼ represents the jth individual among the neighborhood solutions, and the individual is obtained by randomly swapping the initial solution Xₛ for I times;
step S62, defining variable N′(Xₛ)={X′₁, . . . , X′ⱼ, . . . , X′_{W}}, which has the same meaning as N(Xₛ), and assigning the individuals in N(Xₛ) to N′ (Xₛ); and letting variable j=1;
step S63, randomly generating random numbers denoted as index1 and index2 in the range of an interval [1, W], with index1, index2 and j differing from one another;
step S64, defining variables Vⱼ and Uⱼ, with Vⱼ and Uⱼ being in the same dimension with the individual Xⱼ; letting variable d=1; generating a random number random in the range of an interval (0,1], and assigning the random number to variable F;
step S65, updating V_{jd} by equation V_{jd}=X_{bd}+F×(X_{index1d}−X_{index2d}), wherein X_{bd} representing the dth element in the global optimal solution;
step S66, randomly generating a random number rand in the range of the interval (0,1], and determining whether rand≤CR is true; if yes, assigning V_{jd} to U_{jd}; otherwise, assigning X_{jd} to U_{jd};
step S67, assigning d+1 to d, and determining whether d≤l is true; if yes, returning to the step S65; otherwise, performing step S68;
step S68, calculating fitness values F(X′ⱼ) and F(Uⱼ) of individual X′ⱼ and intermediate Uⱼ, and comparing F(X′ⱼ) with F(Uⱼ); if F(X′ⱼ)≤F(Uⱼ), assigning Uⱼ to the individual Xⱼ;
step S69, assigning j+1 to j, and determining whether j≤W is true; if yes, returning to the step S63; otherwise, performing step S610; and
step S610, considering Q individuals in the candidate solution set which is denoted as List(Xₛ), sorting the W individuals in N(Xₛ) in non-decreasing order by fitness value, picking out first Q individuals from the sequence, and assigning the chosen Q to List (Xₛ).

7. The system according to claim 5, wherein in the step S12 implemented through loading and execution of the at least one instruction by the at least one processing unit, the process of updating the tabu list TSList according to the initial solution Xₛ comprises:
step S121, determining a job batch set Bₖ on the kth machine according to the initial solution Xₛ;
step S122, picking out ┐|Bₖ|/2└ job batches from Bₖ to form a batch set B′ₖ, wherein variable |Bₖ| represents the number of job sets in the set Bₖ;
step S123, repeating the step S122 until each machine has a chosen set, thereby forming a tabu list element denoted as S={B′₁, . . . , B′ₖ, . . . , B′ₘ};
step S124, determining whether S is identical to all existing elements of the tabu list, and if an element is identical to S, returning to the step S122; and
step S125, inserting S into the tabu list, and then removing the first element inserted in the tabu list.

8. The system according to claim 5, wherein in the step S13 implemented through loading and execution of the at least one instruction by the at least one processing unit, the process of outputting the fitness value of an individual comprises:
step S131, traversing all elements in individual X={x₁, . . . , x_{d}, . . . , xₗ}, and defining variable d=1, with variable Bₖ representing a set of job batches assigned to the kth machine, and variable |Bₖ| representing the number of job batches in the set Bₖ;
step S132, determining whether 1≤x_{d}≤m is satisfied; if no, performing step S133; otherwise, performing step S134;
step S133, generating a random integer denoted as random in the range of an interval [1, m], and assigning random to x_{d};
step S134, determining whether x_{d}=k is true, wherein k ∈ {1, . . . , m}, and if yes, placing b_{d} into Bₖ;
step S135, assigning d+1 to d, and determining whether d≤l is true; if yes, returning to the step S132; otherwise, performing step S136;
step S136, defining variable k=1;
step S137, defining variables j=1 and Cₖ=0, wherein Cₖ represents the completion time of the kth machine;
step S138, assigning C_{b}_{ₖⱼ}=C_{b}_{_{kj−1}}+P_{b}_{ₖⱼ}/vₖ to Cₖ, wherein P_{b}_{ₖⱼ} represents the processing time of the jth batch on the kth machine;
step S139, assigning j+1 to j, and determining whether j≤|Bₖ| is true; if yes, returning to the step S138; otherwise, assigning Cₖ+rₖ+Tₖ to Cₖ;
step S1310, assigning k+1 to k, and determining whether k≤|Bₖ| is true; if yes, returning to the step S137; otherwise, obtaining a set of makespans of all machines denoted as C*={C₁, . . . , Cₖ, . . . , Cₘ}; and
step S1311, picking out the maximum element from the makespan set C* obtained in the step 1310, and assigning the element to Cₘₐₓ, i.e., Cₘₐₓ=max{C₁, . . . , Cₖ, . . . , Cₘ}, wherein variable Cₘₐₓ represents the fitness value of the individual X.

9. A computer-readable storage medium that stores at least one instruction to be loaded and executed by a processor to implement the method of claim 1.
